(19) United States
(12) Patent Application Publication
(10) Pub. No.: US 2010/0208360 A1
(43) Pub. Date: Aug. 19, 2010

(54) WATERPROOF AND EXTERNALLY MODULATED ZOOM STRUCTURE

(76) Inventors: Huang Kuo Hsiu, Banciao City (TW); Kuo Mu Chung, Lujou (TW)

Correspondence Address: Guice Patents PLLC, 12647 Galveston Court #302, Manassas, VA, 20112, US

(21) Appl. No.: 12/372,852

(22) Filed: Feb. 18, 2009

(51) Int. Cl. G02B 7/10

(52) U.S. Cl. 359/694; 359/513

(57) ABSTRACT

The present invention provides a waterproof and externally modulated zoom structure, which comprises a module, on which there are a first adjusting section and a second adjusting section; the first adjusting section and second adjusting section are covered and affixed inside a housing; several adjusting shafts, which are installed on the first adjusting section and second adjusting section, so as to adjust the zoom of the first adjusting section and second adjusting section; several knobs, which are installed outside of the housing, and connected to a revolving axle that passes through the housing; a driving linkage is affixed on the revolving axle, so that the driving linkage can sleeve over the adjusting shaft; when the knob is turned, it can indirectly drive the adjusting shaft, thus adjusting the zoom of the first adjusting section and second adjusting section, in order to make the images more clear; the structure has advantages of simple structure, few components, low production, and feasibility for mass production.

### BACKGROUND OF INVENTION

1. Field of the Invention

The present invention relates generally to a zoom structure, and more particularly to a zoom structure which is waterproof and externally modulated.

2. Description of Related Art

Zoom modulator for camera lens is the key device in the surveillance system. Lens is like the crystalline lens of human eyes; without it, human eyes would not be able to see objects. Similarly, without camera lens, the images outputted by the camera would be blurry without clear image. The concepts of camera and video camera are the same. When the muscles on human eyes are unable to extend the crystalline lens to the normal position, which is commonly known as nearsightedness, thus the images in front of the eyes would be blurry. The same problem occurs on camera and lens. When the image is blurry, the zoom of lens could be adjusted to change the distance between the CCD chip and datum surface of lens (similar to the position of crystalline lens of human eyes), the blurry images could become clear. Therefore, adjustable zoom lens is important in the CCTV surveillance system.

To prevent moisture from entering the body of camera lens, the conventional technology set up an externally modulating device. However, this technology has poor tightness, thus, moisture is likely to enter the inside of camera, and causing damage to the camera or inferior image quality.

Therefore, the present invention provides a water proof and externally modulated zoom structure, in order to solve the problems found in the prior art.

### SUMMARY OF THE INVENTION

The main objective of the present invention is to provide a waterproof and externally modulated zoom structure, which connects to a driving linkage through a revolving axle, and sleeves over the adjusting shaft of the lens, in order to revolve the lens for micro-zooming.

Another objective of the present invention is to provide a waterproof and externally modulated zoom structure, which affixes a driving linkage on a revolving axle, and connects to an adjusting shaft on the lens; when rotating the revolving axle, it can drive the adjusting shaft for micro-zooming.

To achieve the above-mentioned purposes, the present invention provides a waterproof and externally modulated zoom structure, which comprising: a module, on which there is a first adjusting section and a second adjusting section; the first adjusting section and second adjusting section are covered and affixed inside a housing; several adjusting shafts, which are installed on the first adjusting section and second adjusting section, to adjust the zoom of the first adjusting section and second adjusting section; several knobs, which are installed outside of the housing, and connects to a revolving axle that passes through the housing; a driving linkage is affixed on the revolving axle, so that the driving linkage sleeves over the adjusting shaft, when the knob turns, it can indirectly drive the adjusting shaft, and adjust the zoom of the first adjusting section and second adjusting section, in order to make the images more clear; the structure has advantages of simple structure, few components, low production, and feasibility for mass production.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

Surveillance system has a certain level of efficacy on reporting crimes and preventing burglary, thus, police bureaus worldwide have actively installed surveillance cameras at many locations, which also has promoted the surveillance system industry. Therefore, the manufacturers need to produce more competitive products with newer technology and lower cost.

Referring to FIGS. 1, 2, 3, a module 10, on which there are a shading ring 101, a first adjusting section 12, and a second adjusting section 14; the module 10, shading ring 101, first adjusting section 12, and second adjusting section 14 are covered and affixed inside a housing 16, which is made of metal or plastic material; several adjusting shafts 18 are installed on the first adjusting section 12 and second adjusting section 14, so as to adjust the zoom of the first adjusting section 12 and second adjusting section 14, and display the clear images on the monitor screen (not shown in the figure); several knobs 20, which are installed outside of the housing 16, and connected to a revolving axle 22 that passes through the housing 16; a driving linkage 24 is affixed on the revolving axle 22, so that the driving linkage 24 can sleeve over the adjusting shaft 18; when the knob 20 is turned, it can indirectly drive the adjusting shaft 18, thus adjusting the zoom of the first adjusting section 12 and second adjusting section 14.

Outside of the housing 16 has at least one axle hole 161, which can allow the revolving axle 22 to pass through and affix the knob 20; among which, the axle hole 161 has a watertight ring 162, which allows the housing 16 to be waterproof. Referring to FIGS. 4 and 5, a module 30, on which there are a shading ring 301, a first adjusting section 32, and a second adjusting section 34; the module 30, shading ring 301, first adjusting section 32, and second adjusting section 34 are covered and affixed inside a housing 36; several adjusting shaft 38 are installed on the first adjusting section 32 and second adjusting section 34, so as to adjust the zoom of the first adjusting section 32 and second adjusting section 34; several knob 40, which are installed on the back of the housing 36, and connected to a revolving axle 42 that passes through the housing 36; a driving linkage 44 is affixed on the revolving axle 42, so that the driving linkage 44 can sleeve over the adjusting shaft 38; when the knob 40 is turned, it can indirectly drive the adjusting shaft 38, thus adjusting the first adjusting section 32 and second adjusting section 34 for micro-zooming.

Outside of the housing 36 is a axle hole 46, which allows the revolving axle 42 to pass through and affix the knob 40; the axle hole 46 has a watertight ring 48, which allows the housing 36 to be waterproof.

Although the invention has been explained in relation to its preferred embodiment, it is to be understood that many other possible modifications and variations can be made without departing from the spirit and scope of the invention as hereinafter claimed.

### BRIEF DESCRIPTION OF THE DRAWINGS

FIG. 1 shows a perspective view of the embodiment of the present invention before assembled with a housing.

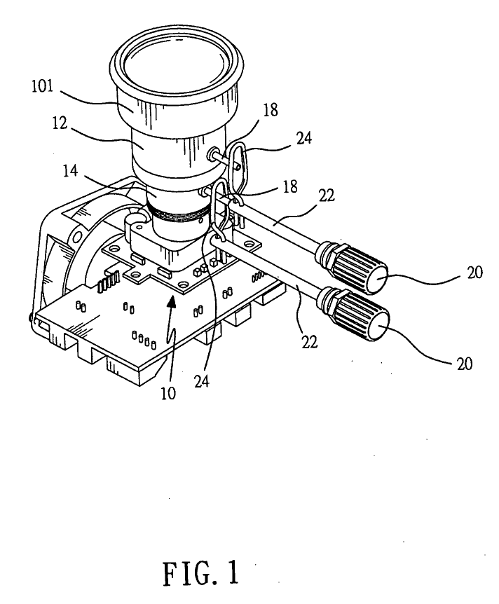

FIG. 2 shows perspective view of the embodiment in FIG. 1 after assembly.

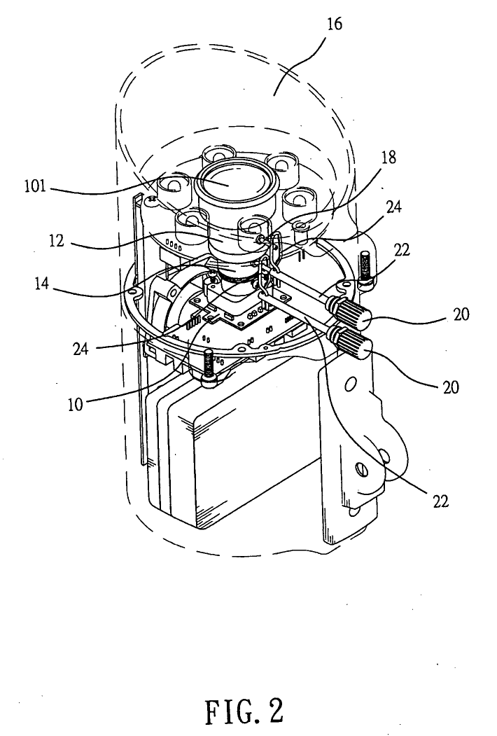

FIG. 3 shows a cross-sectional view of FIG. 2.

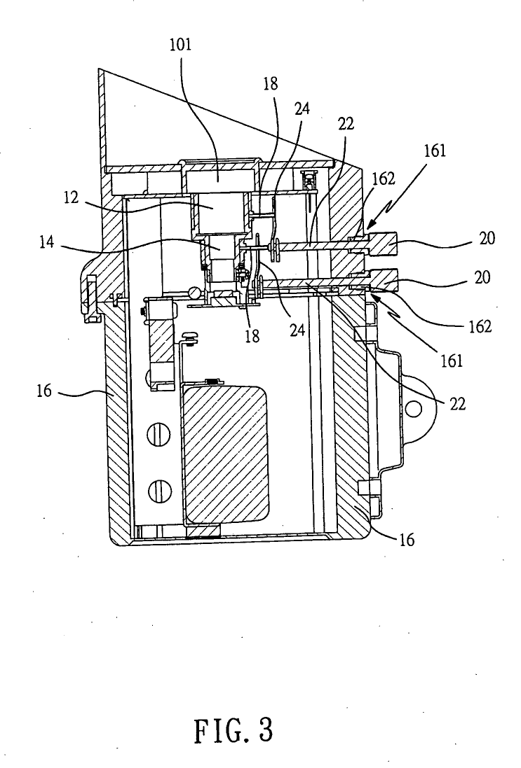

FIG. 4 shows another perspective view of the embodiment of the present invention before assembled with a housing.

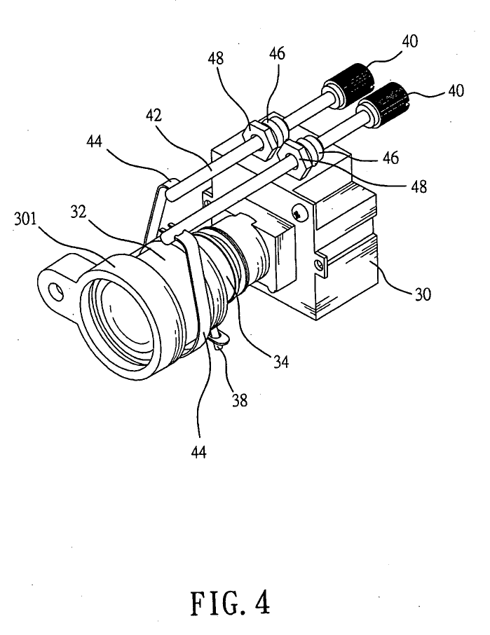

FIG. 5 shows perspective view of the embodiment in FIG. 4 after assembly.

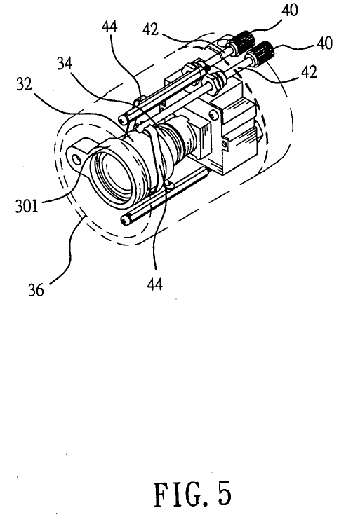

1. A waterproof and externally modulated zoom structure, comprising:
a module, on which there are a shading ring, a first adjusting section, and a second adjusting section; the module, shading ring, first adjusting section, and second adjusting section are covered and affixed inside a housing;
several adjusting shafts, which are installed on the first adjusting section and second adjusting section, so as to adjust the zoom of the first adjusting section and second adjusting section;
several knobs, which are installed outside of the housing, and connected to a revolving axle that passes through the housing; a driving linkage is affixed on the revolving axle, so that the driving linkage can sleeve over the adjusting shaft; when the knob is turned, it can indirectly drive the adjusting shaft, thus adjusting the zoom of the first adjusting section and second adjusting section.

2. The structure defined in claim 1, wherein the outside of the housing has at least one axle hole, which can allow the revolving axle to pass through and affix the knob.

3. The structure defined in claim 2, wherein said axle hole has a watertight ring.

4. The structure defined in claim 1, wherein said housing can be made of metal material.

5. The structure defined in claim 1, wherein said housing can be made of plastic material.

6. A waterproof and externally modulated zoom structure, comprising:
a module, on which there are a shading ring, a first adjusting section, and a second adjusting section; the module, shading ring, first adjusting section, and second adjusting section are covered and affixed inside a housing;
several adjusting shafts, which are installed on the first adjusting section and second adjusting section, so as to adjust the zoom of the first adjusting section and second adjusting section;
several knobs, which are installed on the back of the housing, and connected to a revolving axle that passes through the housing; a driving linkage is affixed on the revolving axle, so that the driving linkage can sleeve over the adjusting shaft; when the knob is turned, it can indirectly drive the adjusting shaft, thus adjusting the zoom of the first adjusting section and second adjusting section.

7. The structure defined in claim 6, wherein the outside of the housing has at least one axle hole, which can allow the revolving axle to pass through and affix the knob.

8. The structure defined in claim 7, wherein said axle hole has several watertight rings.

9. The structure defined in claim 6, wherein said housing can be made of metal material.

10. The structure defined in claim 6, wherein said housing can be made of plastic material.
